(19) United States
(12) Patent Application Publication
(10) Pub. No.: US 2003/0090800 A1
(43) Pub. Date: May 15, 2003

(54) Reflective elements comprising reinforcement particles dispersed within a core

(75) Inventors: Kathleen M. Humpal, Stillwater, MN (US); James P. Mathers, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/000,649

(22) Filed: Nov. 1, 2001

(51) Int. Cl. G02B 5/128; G02B 5/12

(52) U.S. Cl. 359/551; 359/536; 359/540

(57) ABSTRACT

The present invention relates to reflective elements comprising reinforcement particles dispersed within a glass or ceramic core and optical elements partially embedded into the core. The invention further relates to reflective articles, and in particular pavement markings, comprising the reflective elements as well as methods of making the reflective elements.

### FIELD OF THE INVENTION

The present invention relates to reflective elements comprising reinforcement particles dispersed within a glass or ceramic core and optical elements partially embedded into the core. The invention further relates to reflective articles, and in particular pavement markings, comprising the reflective elements as well as methods of making the reflective elements.

### BACKGROUND OF THE INVENTION

The use of pavement markings (e.g., paints, tapes, and individually mounted articles) to guide and direct motorists traveling along a roadway is well known. During the daytime the markings may be sufficiently visible under ambient light to effectively signal and guide a motorist. At night, however, especially when the primary source of illumination is the motorist's vehicle headlights, the markings are generally insufficient to adequately guide a motorist because the light from the headlight hits the pavement and marking at a very low angle of incidence and is largely reflected away from the motorist. For this reason, improved pavement markings with retroreflective properties have been employed.

Retroreflection describes the mechanism where light incident on a surface is reflected so that much of the incident beam is directed back towards its source. The most common retroreflective pavement markings, such as lane lines on roadways, are made by dropping transparent glass or ceramic optical elements onto a freshly painted line such that the optical elements become partially embedded therein. The transparent optical elements each act as a spherical lens and thus, the incident light passes through the optical elements to the base paint or sheet striking pigment particles therein. The pigment particles scatter the light redirecting a portion of the light back into the optical element such that a portion is then redirected back towards the light source.

In addition to providing the desired reflective effects, pavement markings must withstand road traffic and weathering over an extended duration of time.

Vertical surfaces provide better orientation for retroreflection; therefore, numerous attempts have been made to incorporate vertical surfaces in pavement markings, typically by providing protrusions in the marking surface. Vertical surfaces may prevent the build-up of a layer of water over the retroreflective surface during rainy weather which otherwise interferes with the retroreflection mechanism of optical elements exposed on the surface. For these reasons, reflective elements have been developed wherein optical elements are bonded to a core, in order to increase the number of optical elements that are provided in a vertical orientation.

For example, U.S. Pat. No. 5,774,265 relates to a retroreflective element, which may be used in pavement markings, with greatly improved resistance to wear and the effects of weathering. The preferred retroreflective element is comprised of an opacified glass core and ceramic optical elements partially embedded into the core.

### SUMMARY OF THE INVENTION

The present inventors have discovered that by incorporating certain particles into a glass or ceramic core material, the crush strength of the reflective element can be substantially improved. Advantageously, this improvement in crush strength can be obtained without compromising the retroreflective properties of the elements. Surprisingly, in some embodiments the brightness of the reflective element is improved.

In a preferred embodiment, the present invention relates to a pavement marking composition comprising a binder and a plurality of reflective elements at least partially embedded in the binder. The reflective elements comprise a glass or ceramic core having particles dispersed and optical elements partially embedded into the core. The particles have a melt point greater than the softening point of the core material. The reflective elements exhibit at least a 10% increase in crush strength relative to the same reflective elements wherein the core is substantially free of said particles.

The reflective elements are preferably embedded in the binder at a depth ranging from about 20% to about 40% of their diameters. The binder preferably comprises a paint, a thermoplastic material, thermoset material, or other curable material.

In another embodiment, the present invention is a pavement marking tape having a viewing surface and an opposing surface; wherein the viewing surface comprises a binder and a plurality of reflective elements at least partially embedded in the binder, as just described. A backing is provided on the opposing surface and an adhesive is provided on the opposing surface beneath the backing.

In another embodiment, the invention relates to reflective elements comprising a glass or ceramic core having particles dispersed therein and optical elements partially embedded into the core. The particles have a melt point greater than the softening point of the core material. Further, the reflective elements exhibit at least a 10% increase in crush strength relative to the same reflective elements wherein the core is substantially free of said particles.

The reflective elements preferably exhibit at least about a 25% increase in crush strength, more preferably at least about a 50% increase in crush strength and most preferably at least about a 75% increase in crush strength. The coefficient of retroreflection (R_{A}) of the reflective elements is substantially the same as the same reflective elements wherein the core is substantially free of said particles. Preferably, the R_{A} of the reflective elements is at least about 10% greater, more preferably at least about 20% greater and most preferably at least about 40% greater, than the same reflective elements wherein the core is substantially free of said particles. The RA of the reflective elements is typically at least about 3 cd/lux/m² and preferably at least about 7 cd/lux/m². The optical elements are preferably embedded in the core to a depth of about 20% to about 80% of their diameters. The particles preferably have a mean particle size ranging from 1 micron to about 80 microns. For particles having a diameter greater than about 50 microns, the difference in thermal expansion coefficient between the core and the particles is preferably less than about 3×10⁻⁶/° C. The particles are preferably comprised of a composition having a Young's modulus of at least about 150 GPa, more preferably of at least about 200 GPa and most preferably of at least about 300 GPa. The concentration of particles is preferably at least about 5% by volume based on the total volume of the core. Further, the concentration of particles is preferably less than 35% by volume. The core material is preferably glass and preferably diffusely reflecting, whereas the particles preferably comprise aluminum oxide. Glass ceramic beads are preferred optical elements.

In a preferred embodiment, the reflective elements comprise a glass or ceramic core having about 5% by volume to less than 35% by volume of particles, based on the total volume of the core, dispersed therein and optical elements partially embedded into the core. The particles are comprised of a composition having a melt point greater than the softening point of the core and having a Young's modulus of at least about 150 GPa.

In another embodiment, the invention relates to a method of manufacturing a reflective element comprising:

a) preparing a paste comprising:

i) glass or ceramic core ingredient,

ii) particles having a melt point greater than the softening point of the core ingredient,

iii) water, and

iv) binder;

b) forming the paste into a desired core shape; and

c) heating the core while in contact with a plurality of optical elements to a temperature suitable for embedding the optical elements.

### DESCRIPTION OF THE DRAWING

FIG. 1 is a cross-sectional view of the reflective element 10 wherein the optical elements 12 are embedded in the surface of a glass or ceramic core 14 and a plurality of reinforcement particles 16 are dispersed throughout the core. In a preferred embodiment, the core further comprises a plurality of pores and/or particles 18, such as pigment particles, that are less than 1 micron in diameter present on at least the surface of the core to scatter light, such that the core is diffusely reflecting

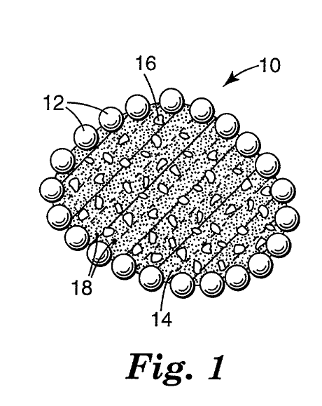

### DETAILED DESCRIPTION OF THE INVENTION

The reflective elements of the invention comprise a glass or ceramic core having reinforcement particles dispersed therein and optical elements partially embedded into the surface of the core. As used herein, “particles” refers to granules, flakes, fibers, beads etc. that generally ranges in size from 1 micron to about 80 microns. The particulate material substantially improves the crush strength in comparison to the same reflective elements wherein the core is substantially free of reinforcement particles, as measured according to the Crush Strength Test, described in detail in the examples. “The same reflective elements” refers to reflective elements comprising the same core composition, the same optical elements, fabricated in substantially the same manner with the only substantial difference being that the core lacks such reinforcement particles. Whereas the core may further comprise other particles such as for example precipitated pigment particles, the terminology “the particles” and “reinforcement particles”, as used herein, refer to the presence of particles that contribute an improvement in crush strength.

The improvement in crush strength is preferably as high as possible without sacrificing the retroreflective properties, nor sufficient embedment of the optical elements in the core. The reflective elements of the invention exhibit an increase in crush strength of at least about 10%, preferably of at least about 25%, more preferably of at least about 50%, and most preferably of at least about 75%, relative to the same reflective elements wherein the core lacks such reinforcement particles. It is surmised that an improvement in crush strength will provide greater durability of the reflective elements, particularly in pavement markings.

As used herein, “optical elements” refers to granules, flakes, fibers, beads etc. that reflect light either independently or when combined with a diffusely reflecting core, as in the case of the preferred optical elements, beads. The optical elements are preferably embedded to a depth sufficient to hold the optical elements in the core during processing and use. Embedment of at least 20% of the diameter, particularly in the case of spherioda[optical elements such as glass ceramic beads, typically will effectively hold the optical element into the core. By 20% embedment, it is meant that about 80% of the total number of optical elements are embedded within the core surface such that about 20% of each bead is sunk into the core and about 80% is exposed on the core surface. If the optical elements are embedded greater than about 80%, the reflective properties tend to be substantially diminished.

The improvement in crush strength, as contributed by the presence of the reinforcement particles, is preferably accompanied by maintained or improved reflectivity as measured according to the Coefficient of Retroreflection Test, described in detail in the examples. The reflective elements may have virtually any size and shape, provided that the coefficient of retroreflection (RA), is at least about 3 cd/lux/m². The preferred size of the reflective elements, particularly for pavement marking uses ranges from about 0.2 mm to about 10 mm and is more preferably about 0.5 mm to about 2 mm. Further, substantially spherical elements are more preferred. For the majority of pavement marking uses, R_{A} is typically at least about 7 cd.lux/m² and preferably about 8 cd/lux/m² and greater. Surprisingly, the incorporation of particles having a mean particle size greater than 1 micron does not detract from the retroreflective properties. One would expect that the presence of such particles would reduce the ability of the core to diffusely reflect light since such particles are typically not effective for light scattering and such particles are displacing other particles within the core which are ideally suited for light scattering. Contrary to this expectation, in preferred embodiments, the presence of the particles improves the coefficient of retroreflection in combination with improving the crush strength. In such preferred embodiments, R_{A} is at least about 10% greater, preferably at least about 20% greater, and most preferably at least about 40% or more greater than the same reflective elements wherein the core lacks such reinforcement particles.

As used herein, “glass” refers to an inorganic material that is predominantly amorphous (a material having no long range order in its atomic structure evidenced by the lack of a characteristic x-ray diffraction pattern). As used herein, “ceramic” refers to an inorganic material that is predominantly crystalline and typically having a microcrystalline, structure (a material having a patterned atomic structure sufficient to produce a characteristic x-ray diffraction pattern). Accordingly, the core material may comprise an amorphous phase (i.e. glass), a crystalline phase (i.e. ceramic), or a combination thereof.

The particles incorporated into the core material have a melt point that is higher than the softening point of the core material, such that the particles maintain their particulate form when manufacturing the reflective element. As used herein, softening temperature refers to the temperature at which the core material has a viscosity of about 10^{7 6} poise. In general, the particles have a melt point of at least about 100° C. greater than the softening point of the base core material. As used herein “base core material” refers to the total core composition excluding the particles. Further, the core material should not react with or solubilize the optical elements, as this tends to reduce transparency and can distort the optical element shape.

Any particle size and concentration of particles may be employed provided that the resulting reflective elements exhibit an improvement in crush strength. The mean particle size of the reinforcement particle typically ranges from about 1 micron to about 300 microns. Preferably, the particle size is as fine as possible. However, the present inventors have discovered that zirconia particles having a mean particle size of 0.9 microns at a concentration of 20 volume % dispersed within an opacified glass core material did not exhibit good embedment with the optical elements, as described in the forthcoming “General Firing Procedure” (i.e. See Comparative Examples 3 and 4).

Accordingly, the mean particle size is preferably at least about 2 microns, more preferably at least about 3 microns, and most preferably at least about 4 microns.

Preferably, the mean particle size of the reinforcement particle is no larger than the mean particle size of the optical elements (e.g. 80 microns). In general, at larger particle sizes (e.g. about 50 to 80 microns), the difference in thermal expansion coefficient between the base core material and the particle material become an important factor. For such large particles, the thermal expansion coefficient of the particle material is closely matched to that of the core material. The difference in thermal expansion coefficient between the base core material and the particle composition is typically less than about 3×10⁻⁶/° C. over the temperature range of ambient temperature to the strain point of the base core material (e.g. 25° C. to 300° C.) for such large particles. The thermal expansion coefficient of various materials is known from the literature. Further, the thermal expansion coefficient of mixtures can be approximately calculated or measured with a dilatometer.

The concentration of particles preferably ranges from at least about 5% by volume to about 33% by volume, with respect to the total volume of the core. The present inventors have discovered that at a concentration of 35% and 40% by volume, alumina particles dispersed within an opacified glass core did not exhibit good embedment with the optical elements as described in the forthcoming “General Firing Procedure” (i.e. See Comparative Examples 1 and 2). Lack of sufficient embedment will result in the optical elements breaking off from the core as a result of the forces the reflective elements are subjected to during use as a pavement marking material.

In general, the Young's modulus of the reinforcement particle is higher than the Young's modulus of the core material. Typically, such as in the case of glass core materials, the Young's modulus is preferably at least about 150 GPa, more preferably at least about 200 GPa, and most preferably at least about 300 GPa. In general, for a given particle size and concentration, the higher the Young's modulus of the particle composition, the higher the corresponding improvement in crush strength.

Although any particle material that contributes the desired properties (e.g. improvement in crush strength, retroreflectivity, embedment) may be employed, Al₂O₃ is a preferred particle material, particularly in view of its relatively high Young's modulus. The purity of commercially available Al₂O₃ generally ranges from about 75% to about 99% or greater. The inclusion of other inorganic oxides, such as zirconia, in combination with Al₂O₃ is typically unproblematic provided that doing so does not detract from the intended properties.

In preferred embodiments, the reflective elements comprise a diffusely reflecting core material comprising the reinforcement particles and optical elements that are substantially free of specular reflecting properties. Hence, in preferred embodiments, the reflective elements are free of metals. Alternatively, however, the reflective elements may comprise a non-diffusely reflecting core (e.g. transparent core) comprising the reinforcement particles in combination with specularly reflecting optical elements, such as would be provided by the glass beads described in U.S. Pat. Nos. 3,274,888 and 3,486,952.

The diffuse reflection of the core material can conveniently be characterized as described in ANSI Standard PH2.17-1985. The value measured is the reflectance factor that compares the diffuse reflection from a sample, at specific angles, to that from a standard calibrated to a perfect diffuse reflecting material. For reflective elements that employ a diffusely reflecting core, the reflectance factor of the core is preferably at least 75% at a thickness of 500 micrometers for retroreflective elements with adequate brightness for highway markings. More preferably, the core has a reflectance factor of at least 85% at a thickness of 500 micrometers.

Diffuse reflection is caused by light scattering within the material. Such light scattering may be due to the presence of pores or the presence of crystalline phases. The size of the pores or the crystalline phases typically range from about 0.05 micrometer to about 1.0 micrometers. Preferably, the size ranges from about 0.1 micrometer to about 0.5 micrometers. The scattering power is maximized when the size of pores or the second phase is slightly less than one-half the wavelength of the incident light, about 0.2 to about 0.4 micrometers. The degree of light scattering is also increased when there is a large difference in the refractive index of the scattering phase or pore and the phase in which it is dispersed. An increase in light scattering is observed typically when the difference in refractive index is greater than about 0.1. Preferably, the refractive index difference is greater than about 0.4. Most preferably, the difference is greater than about 0.8. For the diffusely reflecting core materials employed in the present invention, light scattering is due to a combination of scattering from pores and from various crystalline phases.

Glass is a preferred core material because it can be processed at low temperatures and thus at a lower cost. However, glasses tend to be fully dense, single-phase materials that do not provide sufficient light scattering desired for the reflective elements of the invention comprising a diffusely reflecting core.

Certain combinations of glass phases with dispersed crystalline phases provide excellent scattering. These materials are known as opaque glazes when applied as a coating on a ceramic and as opaque porcelain enamels when applied as a coating on a metal. Because opaque glazes and opaque porcelain enamels contain a large portion of glass, they are often referred to as opacified glasses.

Silicate glasses having a refractive index typically in the range of about 1.5 to about 1.6 are used in both opaque glazes and opaque porcelain enamels. To obtain an adequate difference in refractive index, a scattering phase with a high refractive index is desirable for use in the opacified glass. Materials (opacifiers) which are commonly used for this purpose include tin oxide (SnO₂) with a refractive index of about 2.04; zircon (ZrSiO₄) with a refractive index of about 1.9 to about 2.05; calcium titanate (CaTiO₃) with a refractive index of about 2.35; and titania (TiO₂), anatase and rutile, with a refractive index of about 2.5 to about 2.7.

Preferably, the crystalline phase required for sufficient light scattering, and thus, opacity, is achieved by dissolving the opacifier in the molten glass and quenching. The scattering phase precipitates from the glass during reheating. However, in some cases, the opacifier may not dissolve in the glass, and may be added to the glass as a separate component. Most titania opacified glasses contain 15 to 20 weight percent titania which is largely in solution at temperatures where the porcelain enamel is melted, typically greater than about 1100° C. The titania remains in solution in the quenched glass frits and powders. The titania precipitates into crystals of about 0.2 microns in size upon reheating to the temperature used to embed the optical elements, typically 600-900° C.

Many variations of opacified glasses are sold commercially such as available frorr Ferro Corporation, Cleveland, Ohio under the trade designation “CS-739” and from Pemco Corporation, Baltimore, Md. under the trade designation “P-5C11-P”. Glass and opacifier are available as a homogeneous single material (i.e., the manufacturer has blended and heated the ingredients together to form a melt and then cooled and ground the resulting material which is then sold as a flake or a powder, known as a frit). The glass frit and the opacifier powder may also both be obtained separately and then combined in the manufacturing process.

Glass-ceramics are also useful as a core material. These are ceramics formed by the crystallization of glasses through the use of controlled heat-treatments and/or nucleating agents. The crystalline phase acts to scatter light resulting in a semi-transparent or opaque appearance.

A wide variety of optical elements may be employed in the present invention. The optical elements may be in the form of any shape such as granules, flakes (e.g. aluminum flakes) and fibers provided that the elements are compatible with the size, shape, and geometry of the core. Typically, the optical elements have a refractive index of about 1.5 to about 2.6 and preferably from about 1.5 to about 1.9. Spheroidal transparent elements, also described herein as “beads”, “glass beads” and “glass ceramic beads” are typically preferred. For the presently preferred core dimensions, having a diameter ranging from about 0.2 to about 10 millimeters, the optical elements preferably range in size from about 30 to about 300 micrometers in diameter. Further, the optical elements typically have a relatively narrow size distribution for effective coating and optical efficiency.

The optical elements preferably are comprised of inorganic materials that are not readily susceptible to abrasion. The optical elements (e.g. transparent beads) may comprise an amorphous phase, a crystalline phase, or a combination thereof. However, the optical elements generally comprise a material that is different than the core material such that the melt point or softening point of the optical elements is higher than that of the core material.

The optical elements most widely used in pavement markings are made of soda-lime-silicate glasses. Although the durability is acceptable, the refractive index is only about 1.5, which greatly limits their retroreflective brightness. Higher-index glass optical elements of improved durability that can be used herein are taught in U.S. Pat. No. 4,367,919.

In the case of ceramic optical elements, the optical elements preferably comprise zirconia, alumina, silica, titania, and mixtures thereof. Further improvements in durability and refractive index have been obtained using microcrystalline ceramic optical elements as disclosed in U.S. Pat. Nos. 3,709,706; 4,166,147; 4,564,556; 4,758,469 and 4,772,511. Preferred optical elements are disclosed in U.S. Pat. Nos. 4,564,556; 4,758,469 and 6,245,700; which are incorporated herein by reference in their entirety. These optical elements comprise at least one crystalline phase containing at least one metal oxide. These optical elements also may have an amorphous phase such as silica. The optical elements are resistant to scratching and chipping, are relatively hard (above 700 Knoop hardness), and are made to have a relatively high index of refraction.

The optical elements can be colored to match the marking paints in which they are embedded. Techniques to prepare colored ceramic optical elements that can be used herein are described in U.S. Pat. No. 4,564,556. Colorants such as ferric nitrate (for red or orange) may be added in the amount of about 1 to about 5 weight percent of the total metal oxide present. Color may also be imparted by the interaction of two colorless compounds under certain processing conditions (e.g., TiO₂ and ZrO₂ may interact to produce a yellow color).

Other materials may be included within the retroreflective elements of the present invention. These may be materials added to the core material during preparation, added to the core material by the supplier, and/or added to the retroreflective elements during coating with the optical elements. Illustrative examples of such materials include pigments, skid-resistant particles, materials that enhance the mechanical bonding between the retroreflective element and the binder, and a fluxing agent.

Pigments may be added to the core material to produce a colored retroreflective element, in particular yellow may be desirable for yellow pavement markings. For example, praseodymium doped zircon ((Zr, Pr)SiO₄) and Fe₂O₃ or NiO in combination with TiO₂ may be added to provide a yellow color to better match aesthetically a yellow liquid pavement marking often used in centerlines. Cobalt zinc silicate ((Co, Zn)₂ SiO₄) may be added to match a blue colored marking. Colored glazes or porcelain enamels may also be purchased commercially to impart color, for example yellow or blue.

Pigments which enhance the optical behavior may be added. For example, when neodymium oxide (Nd₂O₃) or neodymium titanate (Nd₂TiO₅) is added, the perceived color depends on the spectrum of the illuminating light.

The reflective elements of the invention may be made by known processes, such as described in U.S. Pat. Nos. 5,917,652 and 5,774,265, incorporated herein by reference, with the proviso that the reinforcement particles are incorporated into the core material.

A typical manufacturing method includes preparing a paste of the core ingredients, forming the paste into the desired core shape, and heating the core while in contact with a plurality of optical elements to a temperature suitable for embedding the optical elements. The paste comprises the base core material (e.g. glass, glass-ceramic, or ceramic materials), the reinforcement particles, and typically water as well as a water soluble binder (e.g. polymer) to temporarily bond the materials to each other such that a substantially homogenous core mixture is obtained. Although polymers may be used as temporary binders in the manufacturing process, the finished reflective elements are typically substantially free of polymeric materials. The core is typically preheated to remove volatile components prior to embedding the optical elements. The core is typically buried in a static bed of optical elements in order that the entire core surface comprises the optical elements. Combining a plurality of shaped cores with a plurality of optical elements in a rotary kiln is a preferred means for embedding the optical elements. Alternatively however, the core could be placed on the surface of a layer of optical elements, resulting in only a portion of the core comprising the embedded optical elements. For selectively embedding the optical elements the core surface may be coated with a barrier layer of powder prior to embedding the optical elements.

Preferably, when glass optical elements are used, the fabrication of the retroreflective element occurs at temperatures below the softening temperature of the glass optical elements, so that the optical elements do not lose their shape or otherwise degrade. The optical elements' softening temperature, or the temperature at which the glass flows, generally should be at least about 100° C., preferably about 200° C., above the process temperature used to form the retroreflective element.

When optical elements having a crystalline phase are used, the retroreflective element fabrication temperature preferably does not exceed the temperature at which crystal growth occurs in the crystalline component of the optical elements, otherwise the optical elements may deform or lose their transparency. The transparency of the optical elements depends in part on maintaining the crystal size below the size at which they begin to scatter visible light. Generally, the process temperature used to form the retroreflective element is limited to about 1100° C., and preferably to less than 900° C. Higher process temperatures may cause the optical elements to cloud with a corresponding loss in retroreflective effectiveness.

Fluxing agents may be used to enhance the embedding of the optical elements in the core by lowering the softening temperature of the glass at the surface. Illustrative examples include compounds or precursors for B₂O₃ (boric oxide), Na₂O (sodium oxide), and K₂O (potassium oxide).

The reflective elements of the invention can be employed for producing a variety of reflective products or articles such as retroreflective sheeting and in particular pavement markings. Such products share the common feature of comprising a binder layer and a multitude of reflective elements embedded at least partially into the binder surface such that a least a portion of the reflective elements are exposed on the surface. In the reflective (e.g. retroreflective) article of the invention, at least a portion of the reflective elements will comprise the reflective elements of the invention and thus, the inventive elements may be used in combination with other reflective elements as well as with other optical elements (e.g. transparent beads).

Various known binder materials may be employed including various one and two-part curable binders, as well as thermoplastic binders wherein the binder attains a liquid state via heating until molten. Common binder materials include polyacrylates, methacrylates, polyolefins, polyurethanes, polyepoxide resins, phenolic resins, and polyesters. For reflective paints the binder may comprise reflective pigment. For reflective sheeting, however, the binder is typically transparent. Transparent binders are applied to a reflective base or may be applied to a release-coated support, from which after solidification of the binder, the beaded film is stripped and may subsequently be applied to a reflective base or be given a reflective coating or plating.

The reflective elements are typically coated with one or more surface treatments that alter the binder wetting properties and/or improve the adhesion of the reflective elements in the liquid binder. The reflective elements are preferably embedded to about 20-40%, and more preferably to about 30% of their diameters such that the reflective elements are adequately exposed. Surface treatments that control wetting include various fluorochemical derivatives such as commercially available from Du Pont, Wilmington, Del. under the trade designation “Krytox 157 FS”. Various silanes such as commercially available from OSI Specialties, Danbury, Conn. under the trade designation “Silquest A-1100” are suitable as adhesion promoters.

The reflective elements of the invention are particularly useful in pavement marking materials. The retroreflective elements of the present invention can be dropped or cascaded onto binders such as wet paint, thermoset materials, or hot thermoplastic materials (e.g., U.S. Pat. Nos. 3,849,351, 3,891,451, 3,935,158, 2,043,414, 2,440,584, and 4,203,878). In these applications, the paint or thermoplastic material forms a matrix that serves to hold the retroreflective elements in a partially embedded and partially protruding orientation. The matrix can also be formed from durable two component systems such as epoxies or polyurethanes, or from thermoplastic polyurethanes, alkyds, acrylics, polyesters, and the like. Alternate coating compositions that serve as a matrix and include the retroreflective elements described herein are also contemplated to be within the scope of the present invention.

Typically, the retroreflective elements of the present invention are applied to a roadway or other surface through the use of conventional delineation equipment. The retroreflective elements are dropped from a random position or a prescribed pattern if desired onto the surface, and each retroreflective element comes to rest with one of its faces disposed in a downward direction such that it is embedded and adhered to the paint, thermoplastic material, etc. If different sizes of retroreflective elements are used, they are typically evenly distributed on the surface. When the paint or other film-forming material is fully cured, the retroreflective elements are firmly held in position to provide an extremely effective reflective marker.

The retroreflective elements of the present invention can also be used on preformed tapes (ie. pavement marking sheets) in which the binder and reflective elements are generally provided on the viewing surface of the tape. On the opposing surface a backing such as acrylonitrile-butadiene polymer, polyurethane, or neoprene rubber is provided. The opposing surface of the pavement marking tape also generally comprises an adhesive (e.g., pressure sensitive, heat or solvent activated, or contact adhesive) beneath the backing. During use the adhesive is contacted to the target substrate, typically pavement.

Pavement markings often further comprise skid-resistant particles to reduce slipping by pedestrians, bicycles, and motor vehicles. The skid-resistant particles can be, for example, ceramics such as quartz, aluminum oxide, silicon carbide or other abrasive media.

Objects and advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

Test Methods

Crush Strength Test

Ten grams of a −10, +18 mesh (1-2 mm) sample of reflective elements was placed in a 2.86 cm inner diameter (I.D.) nickel-plated test cylinder equipped with a stainless steel plunger and base plug commercially available from VWR International, West Chester, Pa. Pressure was applied at 453.6 Kg increments up to 4536 Kg using a Model C Carver Laboratory Press commercially available from Fred S. Carver Inc., Menomonee Falls, Wis. The pressure was maintained at each pressure increment for 12 seconds. When 4536 Kg was reached, the pressure was maintained for an additional 2 minutes. The total time for the test was 4 minutes. The amount of reflective elements retained on an 18 mesh (1 mm) screen after the test was reported as percent retained.

Bead Embedment

The percent embedment of the beads in the sample was determined by visual examination of the elements using a microscope. The examination was performed using specimens of whole reflective elements and/or cross-sections of reflective elements. The value that best described the overall embedment of optical elements (i.e. beads) in the core was determined by estimating how much of the bead diameter was embedded in the core material and reported as percent embedment.

Coefficient of Retroreflection (R_{A})

Brightness was measured as the coefficient of retroreflection (R_{A}) by placing enough reflective elements in the bottom of a dish that was at least 2.86 cm in diameter such that no part of the bottom of the dish was visible. Then Procedure B of ASTM Standard E809-94a was followed, using an entrance angle of −4.0 degrees and an observation angle of 0.2 degrees. The photometer used for the measurements is described in U.S. Defensive Publication No. T987,003.

Particle Size

The mean particle size of the particle materials employed in the examples was measured using a Horiba Particle Size Distribution Analyzer CAPA-700, available from Horiba Instruments Incorporated, Ann Arbor, Mich.

General Firing Procedure

The pellets prepared from base core material and reinforcement particles, as described forthcoming in further detail, were placed in a 7.62 cm diameter boron nitride crucible on a bed of glass ceramic beads prepared according to U.S. Pat. No. 6,245,700 to provide beads that had a nominal refractive index of 1.9. For Control A, Examples 1-5 and Comparative Examples 1, 2 and 6, the starting oxide material composition of the beads was by weight 30.9% TiO₂, 15.8% SiO₂, 14.5% ZrO₂, 1.7% MgO, 25.4% A1₂O₃ and 11.7% CaO. For Comparative Examples 3-5, the starting oxide material composition of the beads was by weight 27.3% TiO₂, 13.6% SiO₂, 15.1% ZrO₂, 13.9% MgO, 22.6% Al₂O₃ and 7.5% CaO. The crucible was placed in a furnace from Unitek Corp., Monrovia, Calif. with the trade designation “Ultra-Mat CDF Computerized Display Furnace” and fired in an air atmosphere using one or more of the firing schedules in TABLE I as indicated in each of the forthcoming examples.

TABLE I

| | Firing Schedule (time in minutes) | | | | | | |
|---|---|---|---|---|---|---|---|
| | 1 | 2 | 3 | 4 | 5 | 6 | 7 |
| ˜25° C. to | 5.5 | 5.5 | 5.5 | 5.5 | 5.5 | 5.5 | 5.5 |
| 500° C. | | | | | | | |
| 500° C. to | —* | — | — | 85° C./ | — | — | — |
| 600° C. | | | | min | | | |
| 500° C. to | 85° C./ | — | — | — | — | — | — |
| 625° C. | min | | | | | | |
| 500° C. to | — | — | — | — | 30° C./ | — | 30° C./ |
| 825° C. | | | | | min | | min |
| 500° C. to | — | 30° C./ | 30° C./ | — | — | — | — |
| 850° C. | | min | min | | | | |
| 500° C. to | — | — | — | — | — | 30° C./ | — |
| 875° C. | | | | | | min | |
| 600° C. | — | — | — | 25 | — | — | — |
| 625° C. | 25 | — | — | — | — | — | — |
| 825° C. | — | — | — | — | 5 | — | 10 |
| 850° C. | — | 10 | 5 | — | — | — | — |
| 875° C. | — | — | — | — | — | 5 | — |
| Cool to | 10 | 10 | 10 | 10 | 10 | 10 | 10 |
| ˜25° C. | | | | | | | |

*Not utilized.

### Examples 1-5 and Comparative Examples 1-6

Examples 1-5 and Comparative Examples 1-6 were prepared using either alumina or zirconia as reinforcement particles in reflective element cores, whereas Control A was prepared without reinforcement particles.

For Control A, a 10:1 ratio of the beads described in the General Firing Procedure and a blend of 80 percent −10, +20 mesh (0.8-2 mm) and 20 percent −20, +30 mesh (0.6-0.8 mm) TiO₂ opacified glass frit chips commercially available from Ferro Corporation, Cleveland, Ohio under the trade designation “CS-739” were fired in a 2.5 cm diameter rotary kiln in an air atmosphere at 825° C. The kiln rotation was set at 15 rpm, the slope was set at 0.2 degrees and a double knocker bar was used. The bead embedment, R_{A}, crush strength, and relative crush strength test values for the elements are reported in TABLE II.

Example 1 was prepared by combining 18.1 g of a −325 mesh (<44 um) TiO₂ opacified glass powder commercially available from Pemco Corporation, Baltimore, Md. under the trade designation “P-5C 11-P” with 6.9 g of alpha-alumina (99%) powder commercially available from C-E Minerals, King of Prussia, Pa. under the trade designation “Fused White Alumina 325M”. The ingredients were combined using a mortar with pestle and enough water to make a fluid slurry and were stirred continuously until a stiff mud was formed. The mud was then allowed to dry into a powder cake which was subsequently broken up using a mortar and pestle and screened to −60 mesh (<250 um). The powder was pressed into 5 g pellets using a 2.86 cm I.D. nickel-plated test cylinder equipped with a stainless steel plunger and base plug commercially available from VWR International, West Chester Pa. at 68.9 MPa of pressure. The pellets were fired as described in the General Firing Procedure and using Firing Schedule 1 set out in TABLE I. The fired pellets were then crushed using a mortar and pestle and sized to −10, +18 mesh (1-2 mm). The sized material was then placed in a crucible, surrounded by the beads described in the General Firing Procedure and fired as described in the General Firing Procedure and using Firing Schedule 2 set out in TABLE I. After firing, the resulting elements were screened to −10, +18 mesh (1-2 mm) in size. The bead embedment and RA values for the elements are reported in TABLE II.

Example 2 was prepared as described for Example 1, except Firing Schedule 7 set out in TABLE I was used in place of Firing Schedule 2. The bead embedment, crush strength, and relative crush strength test values for the elements are reported in TABLE I].

Example 3 was prepared by combining 15.1 g of the TiO₂ opacified glass powder used in Example 1 with 9.9 g of the alumina powder used in Example 1. Elements were prepared and fired as described for Example 1. The bead embedment, R_{A}, crush strength and relative crush strength test values for the elements are reported in TABLE II.

Example 4 was prepared by combining 742.5 g of the TiO₂ opacified glass powder used in Example 1, 486.7 g of the alumina used in Example 1, 12.4 g of a methylcellulose polymer commercially available from Dow Chemical Company, Midland, Mich. under the trade designation “Methocel A4M” and 297.0 g water. The ingredients were mixed in a double planetary mixer commercially available from Charles Ross & Son Company, Hauppauge, N.Y. to form a paste.

The prepared paste was sandwiched between two sheets of polyester film using about 40 g of the paste for each sandwich. Each sandwich was calendered using two stainless steel rollers with a gap set at 0.75 mm. The top film was removed from the sandwich and the paste on the bottom film allowed to air dry. The bottom film was removed from the dried paste, resulting in a dried paste thickness of approximately 1.7 mm. The sheets of dried paste were then fired in air to 625° C. on a 91.4 cm long belt furnace. During firing, the sheets were placed on a bed of the beads described in the General Firing Procedure. The temperature zones in the furnace during firing were set as follows: Zone 1=350° C.; Zone 2=500° C.; Zone 3=625° C.

The belt speed was set at 21, which resulted in a time of 1 hour and 20 minutes for a sheet to travel through the 91.4 cm long furnace. The fired sheets were then crushed using a mortar and pestle and screened to −10, +18 mesh (1-2 mm). The −10, +18 mesh material was then mixed with beads described in the General Firing Procedure in a 10:1 ratio of beads to reinforced core material and fired in a 7.6 cm diameter rotary kiln in air at 850° C. The rotary kiln speed was set at 8 rpm and the slope was set at 3 degrees. This resulted in a kiln residence time of 8-10 minutes for the elements. The result was reflective elements consisting of approximately 30 volume percent alumina particle reinforced cores with beads embedded as a mono layer on the core. The resulting elements were screened to −10, +18 mesh. The bead embedment, RA, crush strength, and relative crush strength test values for the elements are reported in TABLE II.

Comparative Example 1 was prepared by combining 13.72 g of the TiO₂ opacified glass powder of Example 1 with 11.28 g of the alumina of Example 1. The ingredients were combined using a mortar with pestle and enough water to make a fluid slurry and were stirred continuously until a stiff mud was formed. The mud was then allowed to dry into a powder cake which was subsequently broken up using a mortar and pestle and screened to −60 mesh (<250 um). An approximately 1 g pellet was pressed from this powder using a 13 mm diameter cylindrical die set available from SPEX CertiPrep, Metuchen, N.J. under the trade designation “3613” at 68.9 MPa. The pellet was fired as described in the General Firing Procedure using Firing Schedule 1. The pellet was then covered with the beads described in the General Firing Procedure and fired according to Firing Schedule 3 set out in TABLE I. The bead embedment value for the elements is reported in TABLE II.

Comparative Example 2 was prepared as described for Comparative Example 1, except that 12.4 g of the TiO₂ opacified glass powder of Example 1 was combined with 12.6 g of the alumina of Example 1. The bead embedment value for the elements is reported in TABLE II.

Comparative Example 3 was prepared as described for Comparative Example 1, except that 8.75 g of zirconia powder commercially available from Z-tech Division, Bow NH under the trade designation “CF-Plus” was combined with 16.25 g of the TiO₂ opacified glass powder of Example 1. The pellet was fired using Firing Schedule 4 and then Firing Schedule 5. The bead embedment value for the elements is reported in TABLE II.

Comparative Example 4 was prepared as described for Comparative Example 3, except that Firing Schedule 4 and then Firing Schedule 6 were used. The bead embedment value for the elements is reported in TABLE II.

Comparative Example 5 was prepared as described for Comparative Example 3, except that 7.0 g of the zirconia powder of Comparative Example 3 was combined with 18.0 g of the TiO₂ opacified glass powder of Example 1. Firing Schedule 4 and then Firing Schedule 5 were used. The bead embedment value for the elements is reported in TABLE II

Comparative Example 6 powder was prepared as described for Comparative Example 3, except that the zirconia powder used was that commercially available from C & L Development Corporation, Saratoga, Calif. under the trade designation “HW-99P”. Pellets and elements were prepared following the procedure of Example 1. The bead embedment, crush strength, and relative crush strength test values for the elements are reported in TABLE II.

Set out in TABLE II is the reinforcement particle type, size and amount. Also set out are the percent bead embedment, the brightness defined as the Coefficient of Retroreflection (R_{A}) and Crush Strength Test values determined using the Test Methods described above. The Relative Crush Strength values in the table are the Crush Strength Test result, reported as percent retained on an 18 mesh screen, of a reinforced core sample normalized by the Crush Strength Test result of Control A, an unreinforced core sample.

TABLE II

| | Reinforcement Particle | Bead | | Crush | Relative |
|---|---|---|---|---|---|
| | Type; Size (um); | Embedment | R_{A} | Strength Test | Crush |
| Ex. No. | Amount (Vol. %) | (%) | (cd/lux/m²) | (% Retained) | Strength |
| Control A | None | 30-50 | 8.0 | 38.9 | 1.00 |
| 1 | Alumina; 10.3; 20 | 20-50 | 8.8 | — | — |
| 2 | Alumina; 10.3; 20 | 30-50 | — | 49.6 | 1.28 |
| 3 | Alumina; 10.3; 30 | 20-50 | 9.3 | 58.6 | 1.51 |
| 4 | Alumina; 10.3; 30 | 30 | 11.7 | 68.9 | 1.77 |
| Comp. 1 | Alumina; 10.3; 35 | Weak Tack** | — | — | — |
| Comp. 2 | Alumina; 10.3; 40 | Weak Tack | — | — | — |
| Comp. 3 | Zirconia; 0.9; 20 | 0-5 | — | — | — |
| Comp. 4 | Zirconia; 0.9; 20 | 0-5 | — | — | — |
| Comp. 5 | Zirconia; 0.9; 15 | 0-5 | — | — | — |
| Comp. 6 | Zirconia; 4.0; 20 | 30-50 | — | 40.1 | 1.03 |

*Not measured. In the case of Example 1, there was insufficient sample to conduct the Crush Strength Test. In the case of the comparative examples, no further testing was conducted for samples exhibiting poor bead embedment.
**Beads were adhered to the core, but were easily removed by hand with a sharp instrument.

Control A represents preferred reflective elements that lack particle reinforcement. Control A is surmised to have a higher crush strength than the same composition would have if prepared as described in the inventive examples. Examples 2-4 in comparison to Control A demonstrate that the inclusion of reinforcement particles improves the crush strength. Examples 1, 3-4 in comparison to Control A show that the reflective elements of the invention further exhibit improved retroreflective properties. Example 2 in comparison to Examples 3 and 4 exhibit that increasing the concentration of reinforcement particles generally increased the improvement in crush strength. Comparative Examples 1 and 2 demonstrate that less than 35 volume % of particles was preferred for good bead embedment. Comparative Examples 3 and 4 exhibit that a mean particle size of greater than 1 micron was preferred to obtain satisfactory bead embedment. Comparative Example 4 in comparison to Comparative Example 3 demonstrated that increasing the firing temperature did not improve the bead embedment for mean particle sizes of less than 1 micron. Comparative Example 5 in comparison to Comparative Example 3 showed that reducing the concentration of particles did not improve the bead embedment for mean particle sizes of less than 1 micron. Comparative Example 6 demonstrates that good bead embedment was obtained with a mean particle size of 4 microns.

### Example 5

Example 5 was a pavement marking construction prepared by extruding a base coating onto a release liner and then immediately applying reflective elements and optical elements onto the base coating.

A static mixer was used to extrude a two part polyurea base coating commercially available from Minnesota Mining and Manufacturing Company (3M), St. Paul, Minn. under the trade designation “3M Stamark Liquid Pavement Marking Series 1500” onto a crosslinked acrylic coated paper release liner. The liner was pulled through a notch bar set at a height of 0.6 mm which resulted in a coating thickness of 0.5 mm.

The reflective elements of Example 4 were surface treated first with “Silquest A-1100” adhesion promoting agent by first diluting the “Silquest A-1100” with approximately 8% by weight water such that the amount was sufficient to coat the elements and provide 600 ppm on the dried elements. The elements were then treated with a fluorochemical surface treatment (“FC805”) to control the binder wetting properties in a similar manner to provide 16 ppm of such treatment. Each surface treatment was applied by placing the elements in a stainless steel bowl and drizzling the diluted solution of the surface treatment over the elements while continuously mixing to provide wetting of each element. After each treatment, the elements were placed in an aluminum drying tray at a thickness of about 1.9 cm and dried in a 66° C. oven for approximately 30 minutes.

After removal from the oven, the reflective elements surface treated with both the adhesion promoting aid and the floatation aid were put in ajar equipped with a lid containing holes of a size just large enough to allow the elements to be applied onto a just coated 10.2 cm×45.7 cm area of the base coating at a coating weight of 160.8 g/m². Immediately following application of the reflective elements, optical elements consisting of 1.5 index glass beads (sized to meet the specification according to AASHTO M 247 Type 1 as tested by ASTM D 1214; having 70% minimum rounds according to ASTM D 1155: passing AASHTO M 247-81 for moisture resistance; containing by weight 60% beads treated for bonding or sinking and 40% beads treated for bonding and floatation; pre-blended as delivered) commercially available from Flex-O-lite, Chesterfield, Mo. were applied to the binder in the same manner described above for the reflective elements, except at a coating weight of 386.3 g/m².

After curing for about 1 hour at ambient temperature, the brightness described as the coefficient of retroreflected luminance (RL) of the construction was measured according to ASTM E 1710 using a retroreflectometer that measured a 30 meter CEN (i.e. Comite Europeen De Normalisation in French or European Committee for Standardization in English) geometry commercially available from Delta Light and Optics, Lyngby, Denmark under the trade designation “LTL 2000 Retrometer”. The average of four measurements was 997 mcd/m²/lux. This demonstrates that a construction suitable for use as a pavement marker was prepared using the reflective elements of the invention.

What is claimed is:

1. A pavement marking composition comprising a binder and a plurality of reflective elements at least partially embedded in the binder; wherein the reflective elements comprise a glass or ceramic core having particles dispersed therein and optical elements partially embedded into the core; wherein the particles have a melt point greater than the softening point of the core material and the reflective elements exhibit at least about a 10% increase in crush strength relative to the same reflective elements wherein the core is substantially free of said particles.

2. The pavement marking composition of claim 1 wherein said reflective elements exhibit at least about a 25% increase in crush strength.

3. The pavement marking composition of claim 1 wherein said reflective elements exhibit at least about a 50% increase in crush strength.

4. The pavement marking composition of claim 1 wherein said reflective elements exhibit at least about a 75% increase in crush strength.

5. The pavement marking composition of claim 1 wherein the R_{A} of the reflective elements is substantially the same as the same reflective elements wherein the core is substantially free of said particles.

6. The pavement marking composition of claim 1 wherein the R_{A} of the reflective elements is at least about 10% greater than the same reflective elements wherein the core is substantially free of said particles.

7. The pavement marking composition of claim 1 wherein the R_{A} of the reflective elements is at least about 20% greater than the same reflective elements wherein the core is substantially free of said particles.

8. The pavement marking composition of claim 1 wherein the R_{A} of the reflective elements is at least about 40% greater than the same reflective elements wherein the core is substantially free of said particles.

9. The pavement marking composition of claim 1 wherein the R_{A} of the reflective elements is at least about 3 cd/lux/m².

10. The pavement marking composition of claim 1 wherein the R_{A} of the reflective elements is at least about 7 cd/lux/m².

11. The pavement marking composition of claim 1 wherein the optical elements are embedded in the core to a depth of about 20% to about 80% of their diameters.

12. The pavement marking composition of claim 1 wherein the particles have a mean particle size ranging from about 1 micron to about 80 microns.

13. The pavement marking composition of claim 12 wherein the particles have a diameter greater than about 50 microns.

14. The pavement marking composition of claim 13 wherein the difference in thermal expansion coefficient between the core and the particles is less than about 3×10⁻⁶/° C.

15. The pavement marking composition of claim 1 wherein the particles are comprised of a composition having a Young's modulus of at least about 150 GPa.

16. The pavement marking composition of claim 1 wherein the particles are comprised of a composition having a Young's modulus of at least about 200 GPa.

17. The pavement marking composition of claim 1 wherein the particles are comprised of a composition having a Young's modulus of at least about 300 GPa.

18. The pavement marking composition of claim 1 wherein the concentration of particles is at least about 5% by volume based on the total volume of the core.

19. The pavement marking composition of claim 1 wherein the concentration of particles is less than 35% by volume based on the total volume of the core.

20. The pavement marking composition of claim 1 wherein the core material comprises glass.

21. The pavement marking composition of claim 1 wherein said core is diffusely reflecting.

22. The pavement marking composition of claim 1 wherein the particles comprise aluminum oxide.

23. The pavement marking composition of claim 1 wherein the optical elements are glass ceramic beads.

24. The pavement marking composition of claim 1 wherein the reflective elements are embedded in the binder at a depth ranging from about 20% to about 40% of their diameters.

25. The pavement marking composition of claim 1 wherein the binder comprises a paint, a thermoplastic material, thermoset material, or other curable material.

26. A pavement marking tape having a viewing surface and an opposing surface; wherein the viewing surface comprises the composition of claim 1, a backing is provided on the opposing surface and an adhesive is provided on the opposing surface beneath the backing.

27. Reflective elements comprising a glass or ceramic core having particles dispersed therein and optical elements partially embedded into the core; wherein the particles have a melt point greater than the softening point of the core material and the reflective elements exhibit at least about a 10% increase in crush strength relative to the same reflective elements wherein the core is substantially free of said particles.

28. The reflective elements of claim 27 wherein said elements exhibit at least about a 25% increase in crush strength.

29. The reflective elements of claim 27 wherein said elements exhibit at least about a 50% increase in crush strength.

30. The reflective elements of claim 27 wherein said elements exhibit at least about a 75% increase in crush strength.

31. The reflective elements of claim 27 wherein the R_{A} of the reflective elements is substantially the same as the same reflective elements wherein the core is substantially free of said particles.

32. The reflective elements of claim 27 wherein the R_{A} of the reflective elements is at least about 10% greater than the same reflective elements wherein the core is substantially free of said particles.

33. The reflective elements of claim 27 wherein the R_{A} of the reflective elements is at least about 20% greater than the same reflective elements wherein the core is substantially free of said particles.

34. The reflective elements of claim 27 wherein the R_{A} of the reflective elements is at least about 40% greater than the same reflective elements wherein the core is substantially free of said particles.

35. The reflective elements of claim 27 wherein the R_{A} of the reflective elements is at least about 3 cd/lux/m².

36. The reflective elements of claim 27 wherein the R_{A} of the reflective elements is at least about 7 cd/lux/m².

37. The reflective elements of claim 27 wherein the optical elements are embedded in the core to a depth of about 20% to about 80% of their diameters.

38. The reflective elements of claim 27 wherein the particles have a mean particle size ranging from about 1 micron to about 80 microns.

39. The reflective elements of claim 38 wherein the particles have a diameter greater than about 50 microns.

40. The reflective elements of claim 39 wherein the difference in thermal expansion coefficient between the core and the particles is less than about 3×10⁻⁶/° C.

41. The reflective elements of claim 27 wherein the particles are comprised of a composition having a Young's modulus of at least about 150 GPa.

42. The reflective elements of claim 27 wherein the particles are comprised of a composition having a Young's modulus of at least about 200 GPa.

43. The reflective elements of claim 27 wherein the particles are comprised of a composition having a Young's modulus of at least about 300 GPa.

44. The reflective elements of claim 27 wherein the concentration of particles is at least about 5% by volume based on the total volume of the core.

45. The reflective elements of claim 27 wherein the concentration of particles is less than 35% by volume based on the total volume of the core.

46. The reflective elements of claim 27 wherein the core material comprises glass.

47. The reflective elements of claim 27 wherein said core is diffusely reflecting.

48. The reflective elements of claim 27 wherein the particles comprise aluminum oxide.

49. The reflective elements of claim 27 wherein the optical elements are glass ceramic beads.

50. Reflective elements comprising a glass or ceramic core having about 5% by volume to less than 35% by volume of particles, based on the total volume of the core, dispersed therein and optical elements partially embedded into the core; wherein the particles are comprised of a composition having a melt point greater than the softening point of the core and having a Young's modulus of at least about 150 GPa.

51. The reflective elements of claim 50 wherein the particles have a Young's modulus of at least about 200 GPa.

52. The reflective elements of claim 50 wherein the particles have a Young's modulus of at least about 300 GPa.

53. The reflective elements of claim 50 wherein the particles comprise aluminum oxide.

54. A method of manufacturing a reflective element comprising:
a) preparing a paste comprising:
i) glass or ceramic core ingredient,
ii) particles having a melt point greater than the softening point of the core ingredient,
iii) water, and
iv) binder;
b) forming the paste into a desired core shape; and
c) heating the core while in contact with a plurality of optical elements to a temperature suitable for embedding the optical elements.
